(19) United States
(12) Patent Application Publication
(10) Pub. No.: US 2026/0140662 A1
(43) Pub. Date: May 21, 2026

(54) MEMORY CONTROLLER CIRCUIT AND OPERATION METHOD OF THE SAME

(71) Applicant: SigmaStar Technology Ltd., Xiamen (CN)

(72) Inventors: HONGJIANG LIU, Shanghai (CN); TIAN GAO, Shanghai (CN)

(21) Appl. No.: 19/371,230

(22) Filed: Oct. 28, 2025

(30) Foreign Application Priority Data
Nov. 19, 2024 (CN) 202411659876.7

(51) Int. Cl. G06F 3/06

(52) U.S. Cl. CPC G06F 3/0656; G06F 3/0613; G06F 3/0659; G06F 3/0661; G06F 3/0673

(57) ABSTRACT

A memory controller circuit includes a data buffer circuit, a data hold circuit and a control circuit. The data buffer circuit stores data read from a memory, which includes a plurality of memory banks and a plurality of channels corresponding to the memory banks. The data hold circuit is coupled to the plurality of channels. The control circuit is configured to, according to a memory bank ID from a data read command, control the data hold circuit to not enable a target channel corresponding to the memory bank ID and to hold target data on the target channel at the target channel when a storage capacity of the data buffer circuit is full, and control the data hold circuit to enable the target channel to read the target data on the target channel to the data buffer circuit when the storage capacity of the data buffer circuit is not full.

This application claims the benefit of China application Serial No. CN202411659876.7, filed on Nov. 19, 2024, the subject matter of which is incorporated herein by reference.

### BACKGROUND OF THE INVENTION

### Field of the Invention

The present invention relates to a memory control technique, and more particularly to a memory controller circuit and an operation method of the same.

### Description of the Related Art

During a design process of an electronic system such as a chip, if a memory is to be accessed by a processing circuit used for performing high-speed calculations, a chip bus is usually utilized. Because such chip bus may not be able to directly access the memory, the electronic system is then provided with a memory controller circuit as an interface between the processing circuit and the memory, so as to achieve the purpose of access by means of data format conversion.

For data returned from the memory, a buffer circuit arranged in the memory controller circuit first buffers the data which is then further read by the processing circuit. However, in case that the buffer circuit has a large depth, a circuit area of the buffer circuit will be frequently increased. On the other hand, in case that the buffer circuit has a small depth, the throughput and performance of transmission of data may be likely reduced.

### SUMMARY OF THE INVENTION

In view of the issues of the prior art, it is an object of the present invention to provide a memory controller circuit and an operation method of the same to improve the prior art.

The present invention provides a memory controller circuit, which includes a data buffer circuit, a data hold circuit and a control circuit. The data buffer circuit stores data read from a memory, which includes a plurality of memory banks and a plurality of channels corresponding to the memory banks. The data hold circuit is coupled to the plurality of channels. The control circuit is configured to, according to a memory bank ID from a data read command, control the data hold circuit to not enable a target channel corresponding to the memory bank ID and to hold target data on the target channel within the target channel when a storage capacity of the data buffer circuit is full, and control the data hold circuit to enable the target channel to read the target data on the target channel to the data buffer circuit when the storage capacity of the data buffer circuit is not full.

The present invention further provides an operation method of a memory controller circuit. The operation method is applied to the memory controller circuit, and includes: determining, by a controller circuit, whether a storage capacity of a data buffer circuit is full, wherein the data buffer circuit stores data read from a memory, and the memory includes a plurality of memory banks and a plurality of channels corresponding to the plurality of memory banks; controlling, by the controller circuit, according to a memory bank ID from a data read command, a data hold circuit coupled to the plurality of channels not to enable a target channel corresponding to the memory bank ID and to hold target data on the target channel within the target channel when a storage capacity of the data buffer circuit is full; and controlling, by the controller circuit, the data hold circuit to enable the target channel to read the target data on the target channel to the data buffer circuit when the storage capacity of the data buffer circuit is not full.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 shows a block diagram of an electronic system according to an embodiment of the present invention.

FIG. 2 shows a block diagram of a memory controller circuit according to an embodiment of the present invention.

FIG. 3 shows a flowchart of an operation method of a memory controller circuit according to an embodiment of the present invention.

FIG. 4 shows a flowchart of an operation method of a memory controller circuit according to another embodiment of the present invention.

### DETAILED DESCRIPTION OF THE INVENTION

It is an object of the present invention to provide a memory controller circuit and an operation method of the same. When a storage capacity of a data buffer circuit is full, data returned from a memory circuit is stored on a channel corresponding to a data hold circuit. By holding, by a channel of the memory circuit itself, data to be read, the depth of the data buffer circuit may be decreased to reduce a circuit area, and higher throughput and transmission performance of data may be further maintained.

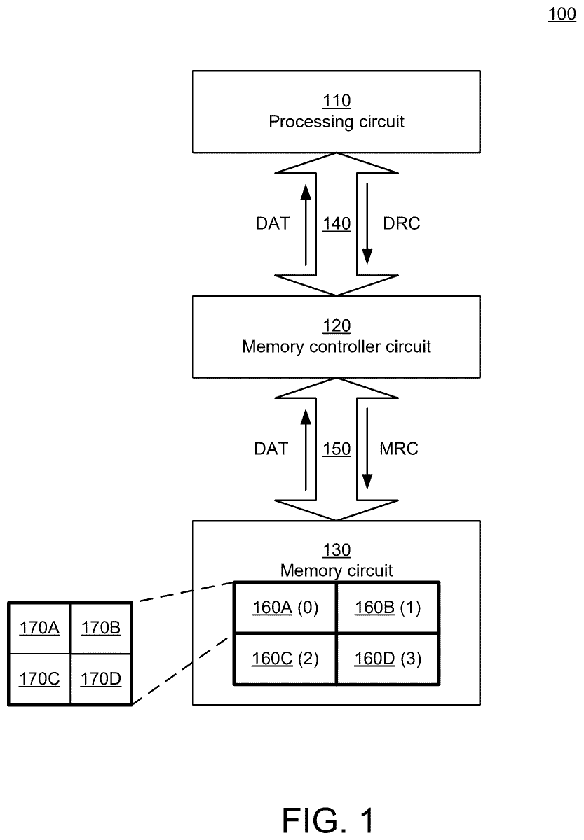

Refer to FIG. 1 showing a block diagram of an electronic system 100 according to an embodiment of the present invention. The electronic system 100 includes a processing circuit 110, a memory controller circuit 120 and a memory circuit 130.

The processing circuit 110 may be, for example, an image signal processor (ISP) or other types of processing circuits, and may communicate with the memory controller circuit 120 via a first interface 140. In one embodiment, the first interface 140 may be an advanced extensible interface (AXI), an advanced peripheral bus (APB) or an advanced high-performance bus (AHB).

The memory circuit 130 may be a static random access memory (SRAM), and may communicate with the memory controller circuit 120 via a second interface 150.

In one embodiment, the memory circuit 130 has a plurality of memory banks 160A to 160D, each of which having a corresponding identity (ID).

In the example shown in FIG. 1, the memory circuit 130 includes four memory banks 160A to 160D, each of which having a corresponding ID, for example, IDs sequentially numbered 0, 1, 2 and 3.

Each of the memory banks 160A to 160D includes a plurality of memory cells in a matrix arrangement, that is, each of the memory banks is arranged as an array of storage units. The memory cells may be a minimum storage unit in the memory circuit 130. In the example shown in FIG. 1, the memory bank 160A includes four storage units 170A to 170D.

The memory controller circuit 120 receives a data read command DRC from the processing circuit 110, retrieves data DAT requested by the data read command DRC from the memory circuit 130 and returns the data DAT to the processing circuit 110 to complete the operation of data reading.

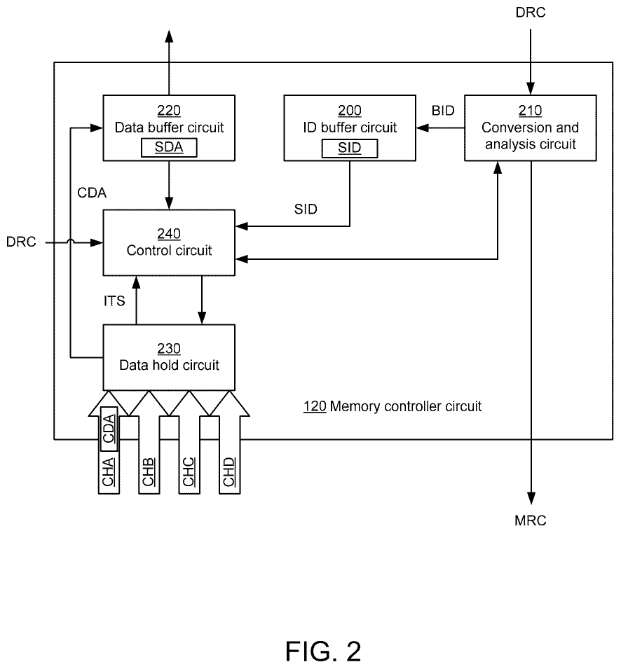

Refer to FIG. 2 showing a block diagram of the memory controller circuit 120 according to an embodiment of the present invention. The memory controller circuit 120 includes an ID buffer circuit 200, a conversion and analysis circuit 210, a data buffer circuit 220, a data hold circuit 230 and a control circuit 240.

The conversion and analysis circuit 210 receives the data read command DRC from the processing circuit 110. The conversion and analysis circuit 210 analyzes the data read command DRC to generate and store a memory bank ID BID to the ID buffer circuit 200. The ID buffer circuit 200 has a predetermined storage capacity, and is able to store a plurality of memory bank IDs BID. In one embodiment, the number of the plurality of memory bank IDs BID that the ID buffer circuit 200 can store is less than or equal to the number of a plurality of channels of the memory circuit 130. Thus, data buffering characteristics of the plurality of channels of the memory circuit 130 can be fully employed to save a buffer space of the memory controller circuit 120. The ID buffer circuit 200 may specifically be, a first-in-first-out (FIFO) buffer circuit. The conversion and analysis circuit 210 further performs format conversion on the data read command DRC to generate and transmit a corresponding memory read command MRC to the memory circuit 130.

Since the processing circuit 110 and the memory circuit 130 use different interfaces for communication, the conversion and analysis circuit 210 performs format conversion on the data read command DRC from a format suitable for the first interface 140 to a format suitable for the second interface 150, so that the memory circuit 130 can receive the format-converted memory read command MRC to accordingly read data.

The memory bank ID BID is included in the data read command DRC and the format-converted memory read command MRC, and may be used to indicate which of the memory banks 160A to 160D of the memory circuit 130 is to be accessed by the command. The memory circuit 130 may accordingly retrieve data from the memory bank corresponding to the memory bank ID BID.

For example, if the value of the memory bank ID BID is 0, the memory circuit 130 may accordingly determine that the corresponding memory bank is the memory bank 160A, and then retrieve the data DAT from at least one storage unit in the memory bank 160A.

The memory circuit 130 includes a plurality of channels CH (for example, channels CHA to CHD), and the plurality of channels CH and the memory banks are in one-on-one correspondence. In practice, the channel CH may be a data bus of a memory bank. It is well known to a person skilled in the art, when a first read request is received, the memory circuit 130 retrieves requested first data from a corresponding memory bank and places the first data on a channel of the memory bank (for example, switching the output enable to a low voltage level state) to wait for a read circuit, for example, the memory controller circuit 120 of the present invention, to obtain the first data from the corresponding channel. When the memory circuit 130 receives a second read request to retrieve second data from the memory bank again, it retrieves the second data and places the second data on the channel in response to the second read request. At this point, the first data previously set on the channel is updated and reset by the second data. Accordingly, it is understandable that the channel CH itself temporarily stores data retrieved from the corresponding memory bank.

The data hold circuit 230 is coupled to the memory circuit 130. More specifically, the data hold circuit 230 is coupled to the plurality of channels CH, and generates an interrupt signal ITS to notify the control circuit 240 that there is data waiting to be written into the data buffer circuit 220 when it is known that the corresponding channel of the memory circuit 130 is set with data. In one embodiment, the ID buffer circuit 200 is a FIFO buffer circuit, and the control circuit 240 reads a memory bank ID SID (for example, a current ID) from the ID buffer circuit 200 in response to the interrupt signal ITS, accordingly determines the corresponding channel of the memory bank ID SID, and accordingly reads the data set on the corresponding channel. In an optional embodiment, the interrupt signal ITS includes memory bank information, for example, the memory bank ID BID, and the control circuit 240 responses to the interrupt signal ITS to determine whether the ID buffer circuit 200 has therein a memory bank ID SID consistent with the memory bank ID. If so, the control circuit 240 again performs related operations to read the data set on the corresponding channel. In another embodiment, the control circuit 240 may first obtain a memory bank ID SID (for example, any one of a plurality of IDs) from the ID buffer circuit 200, and determine the corresponding channel CH of the memory bank ID SID, so as to wait for the interrupt signal ITS returned by the data hold circuit 230 to notify that the channel CH has been set with data to be read. The control circuit 240 determines whether a storage capacity of the data buffer circuit 220 is full in response to the interrupt signal ITS.

When the storage capacity of the data buffer circuit 220 is full, the control circuit 240 controls the data hold circuit 230 to not enable the corresponding channel but to hold corresponding data on the corresponding channel within the corresponding channel.

In one embodiment, the data hold circuit 230 is a multiple-to-one multiplexer. When the storage capacity of the data buffer circuit 220 is full, the control circuit 240 controls the data hold circuit 230 to not enable the corresponding channel to hold the corresponding data to be read on the corresponding channel. More specifically, the data hold circuit 230 may keep the channel in a non-enabled state by maintaining a voltage level on the corresponding channel. For example, if the channel corresponding to the memory bank ID SID is the channel CHA, corresponding data CDA to be read may be held on the channel CHA by means of maintaining the voltage level on the channel CHA via the data hold circuit 230.

Since the corresponding data CDA is held on the corresponding channel and is not substantially read, the control circuit 240 controls the ID buffer circuit 200 to continue storing the memory bank ID SID.

When the storage capacity of the data buffer circuit 220 is not full, the control circuit 240 controls the data hold circuit 230 to enable the corresponding channel to transmit the corresponding data from the corresponding channel to the data buffer circuit 220 for storage, and controls the ID buffer circuit 200 to remove the memory bank ID SID.

More specifically, the control circuit 240 controls the data hold circuit 230 to enable the channel CHA according to the memory bank ID SID, so as to read and store the corresponding data CDA from the channel CHA to the data buffer circuit 220.

Once the corresponding data CDA is stored to the data buffer circuit 220, the control circuit 240 controls the ID buffer circuit 200 to remove the corresponding memory bank ID SID. It is understandable that, the removing of the embodiments of the present invention includes, for example but not limited to, updating the memory bank ID BID.

Further, the data SDA stored to the data buffer circuit 220 may then be accessed by the processing circuit 110. The data buffer circuit 220 removes the data SDA stored in the data buffer circuit 220 after the processing circuit 110 retrieves the data SDA.

Since the memory circuit 130 sequentially receives the first data request and the second data request corresponding to the same memory bank, the first data corresponding to the first read request on the channel is replaced by the second data corresponding to the second read request. In the same memory bank, to prevent data requested by a following data read command DRC from overwriting data requested by a previous data read command DRC but still stored on the channel CH and having not been substantially read to the data buffer circuit 220, after the conversion and analysis circuit 210 analyzes the data read command DRC and generates the memory bank ID BID, the control circuit 240 may determine whether the memory bank ID BID is the same as any memory bank ID SID stored in the ID buffer circuit 200, so as to accordingly control the conversion and analysis circuit 210 to whether perform format conversion on the data read command DRC.

For example, if the conversion and analysis circuit 210 analyzes a data read command DRC and obtains 0 as a value of the memory bank ID BID, and the control circuit 240 also identifies from the ID buffer circuit 200 that a value of one memory bank ID SID is 0, it means that the corresponding channel CHA still has thereon data requested by the previous data read command DRC but not yet read to the data buffer circuit 220. At this point, the control circuit 240 controls the conversion and analysis circuit 210 to not store the memory bank ID BID to the ID buffer circuit 200, and to not perform format conversion on the data read command DRC so as to not transmit the corresponding memory read command MRC to the memory circuit 130.

Conversely, if the conversion and analysis circuit 210 analyzes a data read command DRC and obtains 0 as a value of the memory bank ID BID and the control circuit 240 does not identify any memory bank ID SID having a value 0 in the ID buffer circuit 200, it means that the previous data of the channel CHA has been read to the data buffer circuit 220. At this point, the control circuit 240 controls the conversion and analysis circuit 210 to store the memory bank ID BID to the ID buffer circuit 200, and to perform format conversion on the data read command DRC and transmit the corresponding memory read command MRC to the memory circuit 130, such that the memory circuit 130 places the requested data on the corresponding channel to perform subsequent operations.

The memory controller circuit of the present invention holds data returned from a memory circuit on a corresponding channel coupled to a data hold circuit when a storage capacity of a data buffer circuit is full. By holding, via a channel of the memory circuit itself, data to be read, the depth of the data buffer circuit may be decreased to reduce a circuit area, and higher throughput and transmission performance of data may further maintained.

In one embodiment, to achieve a better resource utilization rate, the depth of the ID buffer circuit 200 is equal to the number of memory bank IDs. Thus, the configuration above can prevent a situation where a storage mechanism is unable to use all channels when the depth of the ID buffer circuit 200 is less than the number of memory bank IDs, as well as resource waste caused by not being able to use an entire depth of the ID buffer circuit 200 when the depth of the ID buffer circuit 200 is greater than the number of memory bank IDs.

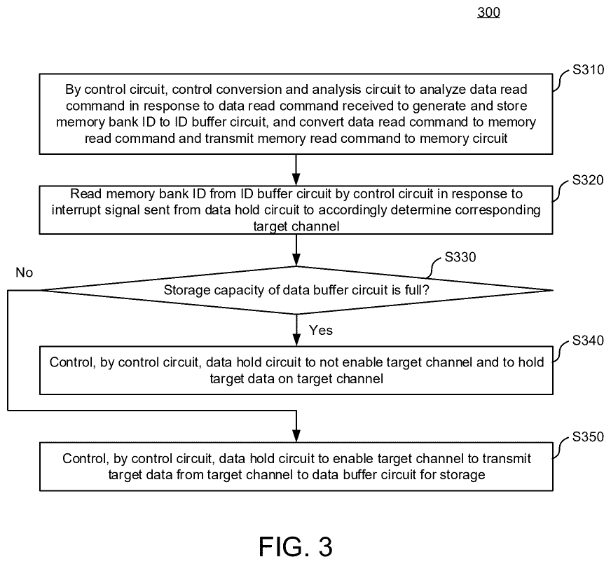

Refer to FIG. 3 showing a flowchart of an operation method 300 of a memory controller circuit according to an embodiment of the present invention. The operation method 300 of the memory controller circuit includes the following steps.

In step S310, the control circuit 240 controls the conversion and analysis circuit 210 to analyze the data read command DRC in response to the data read command DRC received to generate and store the memory bank ID BID to the ID buffer circuit 200, and converts the data read command DRC to the memory read command MRC and transmits the memory read command MRC to the memory circuit 130.

In step S320, the control circuit 240 reads the memory bank ID SID from the ID buffer circuit 200 in response to an interrupt signal sent by the data hold circuit 230 to accordingly determine a corresponding target channel.

In step S330, the control circuit 240 determines whether the storage capacity of the data buffer circuit 220 is full. If so, step S340 is performed; if not, step S350 is performed.

In step S340, the control circuit 240 controls the data hold circuit 230 to not enable the target channel and to hold target data on the target channel within the target channel.

In step S350, the control circuit 240 controls the data hold circuit 230 to enable the target channel to transmit the target data from the target channel to the data buffer circuit 220 for storage.

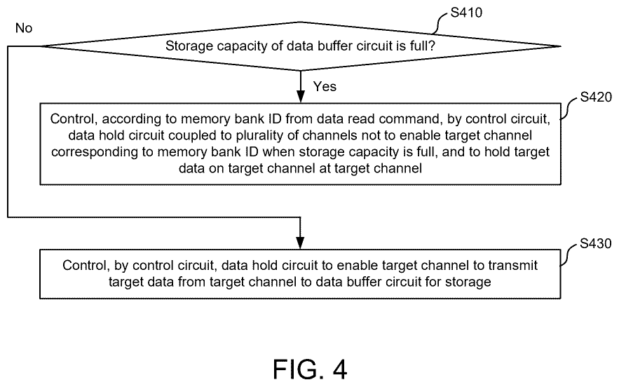

Refer to FIG. 4 showing a flowchart of an operation method 400 of a memory controller circuit according to another embodiment of the present invention. The operation method 400 of the memory controller circuit includes the following steps.

In step S410, the control circuit 240 determines whether the storage capacity of the data buffer circuit 220 is full when the data read command DRC is received.

If so, step S420 is performed; if not, step S430 is performed. In step S420, when the storage capacity is full, the control circuit 240, according to the memory bank ID BID from the data read command DRC, controls the data hold circuit 230 coupled to a plurality of channels to not enable the target channel corresponding to the memory bank ID BID to hold the target data on the target channel within the target channel.

In step S430, when the storage capacity is not full, the control circuit 240 controls the data hold circuit 230 to enable the target channel to read the target data on the target channel to the data buffer circuit 220.

In conclusion, the memory controller circuit of the present invention and the operation method of the same hold data returned from a memory circuit on a channel corresponding to a data hold circuit when a storage capacity of a data buffer circuit is full. By holding, via a channel of the memory circuit itself, data to be read, the depth of the data buffer circuit may be decreased to reduce a circuit area, and higher throughput and transmission performance of data may further maintained.

While the present application has been described by way of example and in terms of the preferred embodiments, it is to be understood that the disclosure is not limited thereto. Various modifications made be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A memory controller circuit, comprising:
a data buffer circuit, storing data read from a memory, wherein the memory comprises a plurality of memory banks and a plurality of channels corresponding to the plurality of memory banks;
a data hold circuit, coupled to the plurality of channels; and
a control circuit, configured to:
according to a memory bank identity (ID) from a data read command, control the data hold circuit to not enable a target channel corresponding to the memory bank ID and to hold target data on the target channel within the target channel when a storage capacity of the data buffer circuit is full; and
control the data hold circuit to enable the target channel to read the target data on the target channel to the data buffer circuit when the storage capacity of the data buffer circuit is not full.

2. The memory controller circuit according to claim 1, wherein the data hold circuit generates an interrupt signal upon learning that the target data is set at the target channel, and the control circuit determines whether a storage capacity of the data buffer circuit is full in response to the interrupt signal.

3. The memory controller circuit according to claim 1, further comprising an ID buffer circuit, and the control circuit reads the memory bank ID from the ID buffer circuit.

4. The memory controller circuit according to claim 3, wherein the control circuit removes the target data from the ID buffer circuit after the target data on the target channel is read to the data buffer circuit.

5. The memory controller circuit according to claim 1, further comprising an ID buffer circuit having a storage capacity for storing a plurality of memory bank IDs, wherein the data hold circuit generates an interrupt signal upon learning that the target data is set at the target channel, and the control circuit determines whether the ID buffer circuit has the memory bank ID stored therein in response to the interrupt signal.

6. The memory controller circuit according to claim 1, further comprising an ID buffer circuit having a storage capacity for storing a plurality of memory bank IDs, wherein the number of the plurality of memory bank IDs is less than or equal to the number of the plurality of channels, and the memory bank ID is one of the plurality of memory bank IDs.

7. The memory controller circuit according to claim 6, further comprising a conversion and analysis circuit that analyzes the data read command to generate the memory bank ID, wherein the control circuit controls the conversion and analysis circuit to store the memory bank ID to the ID buffer circuit when the memory bank ID is not same as any one of the plurality of memory bank IDs stored in the ID buffer circuit, and controls the conversion and analysis circuit to convert the data read command to a memory read command.

8. The memory controller circuit according to claim 6, wherein the control circuit reads target data on the target channel to the data buffer circuit, and accordingly updates the memory bank ID in the ID buffer circuit.

9. An operation method of a memory controller circuit, applied to the
memory controller circuit; the method comprising:
determining, by a control circuit, whether a storage capacity of a data buffer circuit is full, wherein the data buffer circuit stores data read from a memory, and the memory comprises a plurality of memory banks and a plurality of channels corresponding to the plurality of memory banks;
controlling, by the control circuit, according to a memory bank ID from a data read command, a data hold circuit coupled to the plurality of channels to not enable a target channel corresponding to the memory bank ID and to hold target data on the target channel within the target channel when the storage capacity is full; and
controlling, by the control circuit, the data hold circuit to enable the target channel to read the target data on the target channel to the data buffer circuit when the storage capacity of the data buffer circuit is not full.

10. The operation method of a memory controller circuit according to claim 9,
further comprising:
generating, by the data hold circuit, an interrupt signal upon learning that the target data is set at the target channel; and
determining, by the control circuit, in response to the interrupt signal, whether a storage capacity of the data buffer circuit is full.

11. The operation method of a memory controller circuit according to claim 9, wherein the memory controller circuit further comprises an ID buffer circuit having a storage capacity for storing a plurality of memory bank IDs, the number of the plurality of memory bank IDs is less than or equal to the number of the plurality of channels, and the memory bank ID is one of the plurality of memory bank IDs.

12. The operation method of a memory controller circuit according to claim 11, further comprising:
analyzing the data read command, by a conversion and analysis circuit, to generate the memory bank ID; and
controlling, by the control circuit, the conversion and analysis circuit to store the memory bank ID to the ID buffer circuit when the memory bank ID is not same as any one of the plurality of memory bank IDs stored in the ID buffer circuit, and controlling the conversion and analysis circuit to convert the data read command to a memory read command.
